(19) United States
(12) Patent Application Publication
(10) Pub. No.: US 2026/0103033 A1
(43) Pub. Date: Apr. 16, 2026

(54) TIRE EXTERNAL-SCRATCH MONITORING DEVICE, TIRE EXTERNAL-SCRATCH MONITORING METHOD, AND PROGRAM

(71) Applicant: BRIDGESTONE CORPORATION, Tokyo (JP)

(72) Inventor: Shu KONDO, Chuo-ku, Tokyo (JP)

(73) Assignee: BRIDGESTONE CORPORATION, Tokyo (JP)

(21) Appl. No.: 19/116,512

(22) PCT Filed: Nov. 7, 2023
(86) PCT No.: PCT/JP2023/040064

§ 371 Date: Mar. 28, 2025

(30) Foreign Application Priority Data
Dec. 12, 2022 (JP) 2022-198198

(51) Int. Cl. B60C 25/00; G01N 21/88

(52) U.S. Cl. CPC B60C 25/007; G01N 21/8803

(57) ABSTRACT

A tire external-scratch monitoring device according to the present disclosure includes a controller configured to acquire an image of a tire, identify one or more reference positions on an outer surface of the tire as appearing in the image, detect external-scratch on the outer surface of the tire as appearing in the image, and output external-scratch information including positional information for the detected external-scratch relative to the one or more reference positions on the outer surface of the tire.

### TECHNICAL FIELD

The present disclosure relates to a tire external-scratch monitoring device, a tire external-scratch monitoring method, and a program.

### BACKGROUND

Technology for monitoring tire external-scratch is known. For example, Patent Literature (PTL) 1 discloses a tire external-scratch detection system that detects the size of a damaged portion of a tire with respect to the diameter of the rim wheel, based on image data of the tire assembled on the rim wheel.

### CITATION LIST

### Patent Literature

PTL 1: JP 2019-202729 A

### SUMMARY

### Technical Problem

In recent years, further improvement in the usefulness of technology for monitoring tire external-scratch has been desired. For example, there is a desire to identify positional information for external-scratch in a tire so that the state of external-scratch to the tire can be monitored over time.

It is an aim of the present disclosure, conceived in view of such circumstances, to provide a tire external-scratch monitoring device, a tire external-scratch monitoring method, and a program that improve the usefulness of technology for monitoring external-scratch to a tire.

### Solution to Problem

[1] A tire external-scratch monitoring device according to an embodiment of the present disclosure includes a controller configured to: acquire an image of a tire; identify one or more reference positions on an outer surface of the tire as appearing in the image; detect external-scratch on the outer surface of the tire as appearing in the image; and output external-scratch information including positional information for the detected external-scratch relative to the one or more reference positions on the outer surface of the tire.
[2] A tire external-scratch monitoring device according to an embodiment of the present disclosure is the tire external-scratch monitoring device according to [1], wherein the outer surface preferably includes at least one of an outer surface of a side portion or an outer surface of a tread portion of the tire.
[3] A tire external-scratch monitoring device according to an embodiment of the present disclosure is the tire external-scratch monitoring device according to [1] or [2], wherein the controller is preferably further configured to estimate a depth of the external-scratch from at least one of a length or a width of the external-scratch on the outer surface of the tire as appearing in the image, and the external-scratch information preferably includes the depth of the external-scratch.
[4] A tire external-scratch monitoring device according to an embodiment of the present disclosure is the tire external-scratch monitoring device according to [3], wherein the controller is preferably configured to determine an actual length per unit pixel in the image based on an actual length of a reference member associated with the tire and a length of the reference member appearing in the image.
[5] A tire external-scratch monitoring device according to an embodiment of the present disclosure is the tire external-scratch monitoring device according to [3] or [4], wherein the controller is preferably further configured to determine whether the external-scratch is located within a predetermined range from a ground contact position of the tire in the image, and output the external-scratch information including the positional information relative to the one or more reference positions based on the image in a case in which the external-scratch is located within the predetermined range.
[6] A tire external-scratch monitoring device according to an embodiment of the present disclosure is the tire external-scratch monitoring device according to [3] or [4], wherein the controller is preferably further configured to determine whether the external-scratch is located within a predetermined range from a ground contact position of the tire in the image, and estimate the depth of the external-scratch based on the image in a case in which the external-scratch is located within the predetermined range.
[7] A tire external-scratch monitoring device according to an embodiment of the present disclosure is the tire external-scratch monitoring device according to [5] or [6], wherein the predetermined range from the ground contact position of the tire is preferably a range from the ground contact position of the tire to a lower edge of a rim of the tire in a height direction in the image.
[8] A tire external-scratch monitoring device according to an embodiment of the present disclosure is the tire external-scratch monitoring device according to any one of [3] to [7], wherein the controller is preferably configured to output an alert in a case in which the depth of the external-scratch is outside a predetermined threshold range.
[9] A tire external-scratch monitoring device according to an embodiment of the present disclosure is the tire external-scratch monitoring device according to [8], wherein the predetermined threshold range preferably varies depending on the positional information for the external-scratch relative to the one or more reference positions.
[10] A tire external-scratch monitoring device according to an embodiment of the present disclosure is the tire external-scratch monitoring device according to any one of [1] to [9], wherein the image of the tire is preferably a thermographic image captured by a thermographic camera.
[11] A tire external-scratch monitoring device according to an embodiment of the present disclosure is the tire external-scratch monitoring device according to any one of [1] to [10], wherein identifying the one or more reference positions preferably includes identifying at least one reference position among a plurality of reference positions on the outer surface of the tire.
[12] A tire external-scratch monitoring device according to an embodiment of the present disclosure is the tire external-scratch monitoring device according to any one of [1] to [11], wherein outputting the external-scratch information includes outputting a request to visualize and display the external-scratch information for the tire with respect to the one or more reference positions.
[13] A tire external-scratch monitoring method according to an embodiment of the present disclosure is a tire external-scratch monitoring method to be executed by one or more computers, the method including: acquiring an image of a tire; identifying one or more reference positions on an outer surface of the tire as appearing in the image; detecting external-scratch on the outer surface of the tire as appearing in the image; and outputting external-scratch information including positional information for the detected external-scratch relative to the one or more reference positions on the outer surface of the tire.
[14] A program according to an embodiment of the present disclosure is configured to cause one or more computers to execute operations, the operations including acquiring an image of a tire; identifying one or more reference positions on an outer surface of the tire as appearing in the image; detecting external-scratch on the outer surface of the tire as appearing in the image; and outputting external-scratch information including positional information for the detected external-scratch relative to the one or more reference positions on the outer surface of the tire.

### Advantageous Effect

According to the present disclosure, a tire external-scratch monitoring device, a tire external-scratch monitoring method, and a program that can improve the usefulness of technology for monitoring external-scratch to a tire can be provided.

### BRIEF DESCRIPTION OF THE DRAWINGS

In the accompanying drawings:

FIG. 1 is a diagram illustrating a schematic configuration of a tire external-scratch monitoring system according to an embodiment of the present disclosure;

FIG. 2 is a block diagram illustrating a configuration of a server illustrated in FIG. 1;

FIG. 3 is a flowchart illustrating operations of the tire external-scratch monitoring system illustrated in FIG. 1;

FIG. 4 is a diagram illustrating an example of an image of a tire; and

FIG. 5 is a diagram illustrating an example of a screen displaying external-scratch information for the tire.

### DETAILED DESCRIPTION

A tire external-scratch monitoring system according to an embodiment of the present disclosure is described below with reference to the drawings. Members and components that are common across drawings are labeled with the same reference signs. It should be noted that the drawings are schematic, and that the ratios of dimensions and the like may be different from the actual ones.

### Configuration of Tire External-scratch Monitoring System

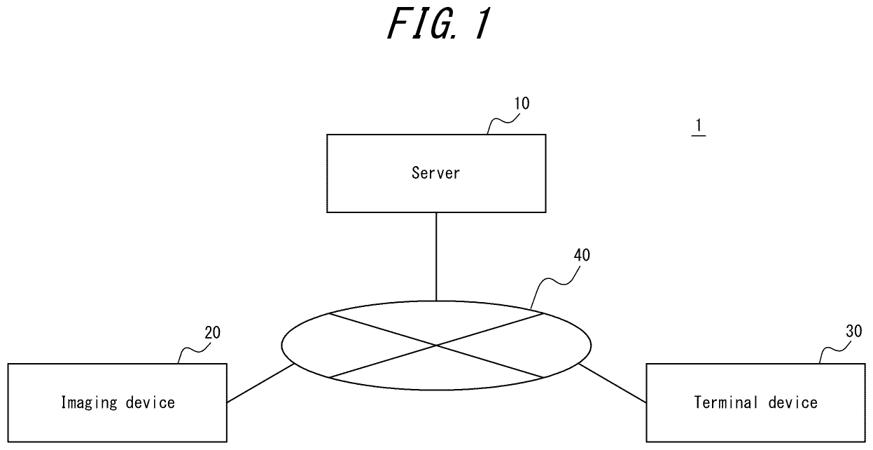

First, an overview of tire external-scratch monitoring system 1 according to the present embodiment is provided with reference to FIG. 1. FIG. 1 is a diagram illustrating a schematic configuration of the tire external-scratch monitoring system 1. As illustrated in FIG. 1, the tire external-scratch monitoring system 1 includes a server 10, an imaging device 20, and a terminal device 30. In FIG. 1, one server 10, one imaging device 20, and one terminal device 30 are each illustrated. The tire external-scratch monitoring system 1 may, however, include any number of servers 10, imaging devices 20, and terminal devices 30.

The server 10 is configured by one or more computers. In the present embodiment, the server 10 is described as being configured by one computer. The server 10 may, however, be configured by a plurality of computers, such as a cloud computing system. In the present disclosure, the server 10 is also referred to as a “tire external-scratch monitoring device”.

The imaging device 20 is configured by a computer that includes at least one camera. The camera is, for example, a visible light camera, but is not limited to such a camera and may be any camera capable of capturing images, such as a thermographic camera or an infrared camera. The image captured by the imaging device 20 may be a still image, such as a photograph, or may be a moving image. The imaging device 20 generates an image of the tire 2 and transmits the image to the server 10. At least a portion of the tire 2 appears in the captured image of the tire 2. In addition to at least a portion of the tire 2, at least a portion of a vehicle 3 on which the tire 2 is mounted may appear in the captured image of the tire 2. The imaging device 20 may be a fixed imaging device installed in the travel path of the vehicle 3 or may be a movable imaging device, such as a tablet device that can be carried by a human being.

The terminal device 30 is, for example, a computer such as a smartphone, tablet device, or personal computer.

The network 40 is any communication network over which the server 10, the imaging device 20, and the terminal device 30 can communicate with each other. The network 40 in the present embodiment may, for example, be the Internet, a mobile communication network, a Local Area Network (LAN), or a combination thereof.

The tire external-scratch monitoring system 1 is used to monitor the external-scratch to one or more tires 2. In the tire external-scratch monitoring system 1, the server 10 acquires an image of a tire 2 from the imaging device 20, for example. The server 10 then identifies one or more reference positions on the outer surface of the tire 2 as appearing in the image and detects external-scratch on the outer surface of the tire 2 as appearing in the image. The server 10 outputs external-scratch information including positional information for the detected external-scratch relative to the one or more reference positions on the outer surface of the tire 2. For example, this external-scratch information for the tire 2 may be transmitted from the server 10 to the terminal device 30 and may be visualized and displayed by the terminal device 30. In this way, the position of the external-scratch on the outer surface of the tire 2 can be accurately identified based on the image acquired from the imaging device 20. The usefulness of technology for monitoring external-scratch to the tire 2 can thereby be improved.

In the present disclosure, the tire 2 is not particularly limited but may be an Off The Road (OR) tire, which is mounted on large vehicles such as construction vehicles, work vehicles, or heavy equipment vehicles used at mine sites and the like. The tire 2 may, however, be a tire other than an OR tire.

In the present disclosure, the vehicle 3 is, for example, a large vehicle, such as a construction vehicle, a work vehicle, or a heavy equipment vehicle used at a mine site or the like. The vehicle 3 is not, however, limited to the above-described large vehicle and may be any vehicle on which the tire 2 can be mounted, such as a truck, bus, passenger car, motorcycle, bicycle, or airplane.

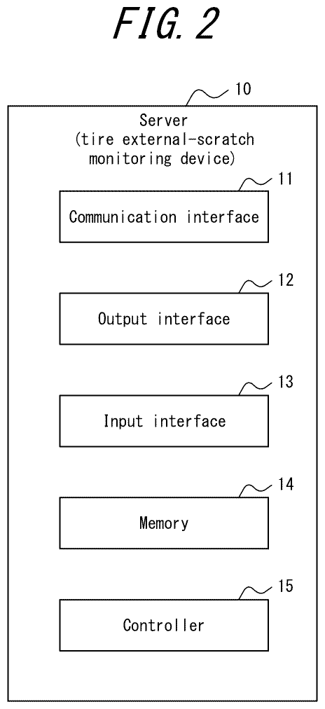

The configuration of the server 10, i.e., the tire external-scratch monitoring device, is now described in detail with reference to FIG. 2. FIG. 2 is a block diagram illustrating the configuration of the server 10. As illustrated in FIG. 2, the server 10 includes a communication interface 11, an output interface 12, an input interface 13, a memory 14, and a controller 15. In the server 10, the communication interface 11, the output interface 12, the input interface 13, the memory 14, and the controller 15 are communicably connected to each other in a wired or wireless manner.

The communication interface 11 includes a communication module for connection to the network 40. The communication module is, for example, a communication module compatible with a mobile communication standard such as 4G (4^{th} Generation) or 5G (5^{th} Generation). The communication module may be a communication module that supports standards such as wired LAN or wireless LAN, for example. The communication module may be a communication module that supports short-range wireless communication standards such as Wi-Fi®, Bluetooth® (Wi-Fi and Bluetooth are each a registered trademark in Japan, other countries, or both), or infrared communication. In the present embodiment, the server 10 is connected to the network 40 via the communication interface 11. This enables the server 10 to communicate with the imaging device 20, the terminal device 30, other computers, and the like.

The output interface 12 includes one or more output devices. The output devices included in the output interface 12 are, for example, a display, a speaker, or a lamp. The output interface 12 thereby outputs images, sound, light, or the like.

The input interface 13 includes one or more input devices. The input devices included in the input interface 13 are, for example, a touch panel, a camera, or a microphone. The input interface 13 accepts input operations by a user of the server 10, for example.

The memory 14 is, for example, a semiconductor memory, a magnetic memory, or an optical memory. The memory 14 functions as, for example, a main memory, an auxiliary memory, or a cache memory. The memory 14 stores any information used in the operation of the server 10. For example, the memory 14 stores system programs, application programs, embedded software, or databases. The information stored in the memory 14 may be updateable with information acquired from the network 40 via the communication interface 11, for example.

For example, the memory 14 may store tire identification information for one or more tires 2 that are subject to external-scratch monitoring. The tire identification information for the tire 2 is information that uniquely identifies the tire 2. The tire identification information is, for example, an ID (Identifier) of the tire 2 uniquely dispensed by the server 10, but is not limited to this and may also be the serial number or the like of the tire 2. Furthermore, the memory 14 may store information about the tire 2 in association with the tire identification information for the tire 2.

The information about the tire 2 may, for example, include at least one of external-scratch information for the tire 2, information on reference positions of the tire 2, information on a reference member of the tire 2, configuration information for the tire 2, information on the vehicle 3 on which the tire 2 is mounted, and information on a position at which the tire 2 is mounted in the vehicle 3. The external-scratch information for the tire 2 may, for example, be time-series data including the position, shape, depth, and registration date and time of external-scratch that the tire 2 has suffered in the past. The information on the reference positions of the tire 2 is information on positions that serve as a reference for identifying the position of the external-scratch on the outer surface of the tire 2. For example, the information on a reference position of the tire 2 includes features such as the shape, color, or pattern of the reference position. The information on the reference position of the tire 2 is, for example, associated with a position on the outer surface of the tire 2 via coordinates or other positional information. The information on the reference member of the tire 2 is information on a member that serves as a reference when the length or the like of the external-scratch appearing in an image 50 is evaluated. The information on the reference member of the tire 2 includes, for example, features such as the shape, color, or pattern of the reference member and the actual length of the reference member. The configuration information for the tire 2 includes, for example, the type, model number, material properties, belt angle, size, or weight of the tire 2. The information on the vehicle 3 on which the tire 2 is mounted includes the identification information, type, model number, displacement, number of tires mounted, number of shafts, and the like of the vehicle 3.

The controller 15 includes one or more processors. The processor may be, for example, a general-purpose processor such as a central processing unit (CPU), or a dedicated processor specialized for a particular process. The controller 15 is not limited to a processor and may include one or more dedicated circuits. The dedicated circuit may, for example, be a field-programmable gate array (FPGA) or an application specific integrated circuit (ASIC). The controller 15 controls the respective components to realize the functions of the server 10, including the functions of components such as the communication interface 11, output interface 12, input interface 13, and memory 14 described above.

### Operations of Tire External-Scratch Monitoring System

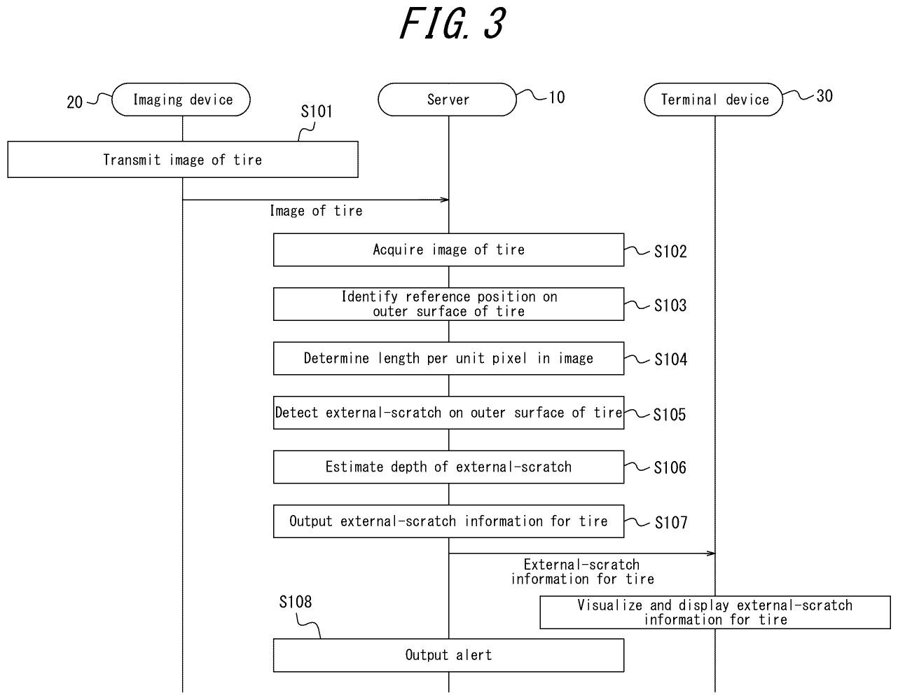

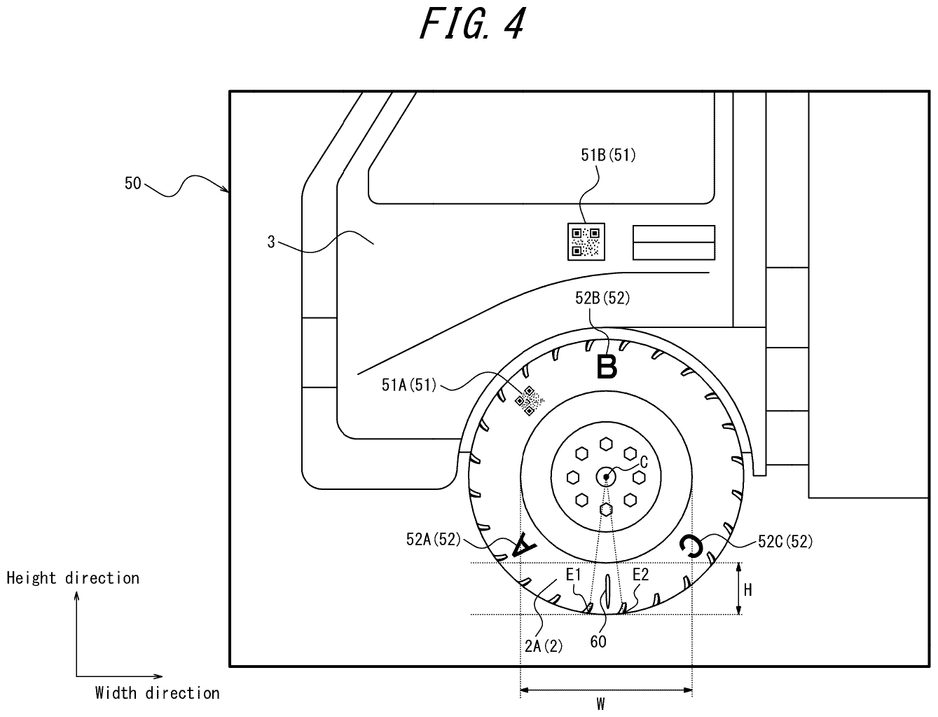

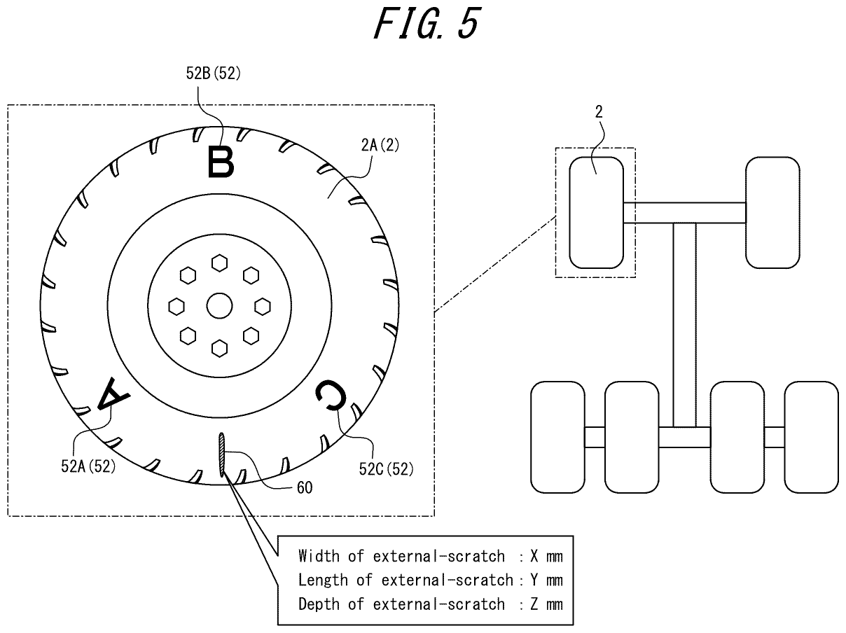

FIGS. 3, 4, and 5 illustrate operations of the tire external-scratch monitoring system 1. FIG. 3 is a flowchart illustrating operations of the tire external-scratch monitoring system 1. FIG. 4 is a diagram illustrating an example of an image 50 of the tire 2. FIG. 5 is a diagram illustrating an example of a screen displaying external-scratch information for the tire 2. The flowchart illustrated in FIG. 3 illustrates operations of the server 10, the imaging device 20, and the terminal device 30 included in the tire external-scratch monitoring system 1. Therefore, the description of these operations corresponds to a control method of the tire external-scratch monitoring system 1 and also corresponds to a control method of each of the server 10, the imaging device 20, and the terminal device 30 included in the tire external-scratch monitoring system 1.

In describing these operations, it is assumed that the controller 15 of the server 10 has stored the tire identification information for the tire 2 and the information about the tire 2 associated with the tire identification information for the tire 2 in the memory 14. As described above, the information about the tire 2 includes, for example, a history of past external-scratch to the tire 2, information on reference positions of the tire 2, and information on a reference member of the tire 2.

The controller 15 of the server 10 may store the actual length per unit pixel in the image 50 in the memory 14 in order to calculate the actual length of the object as appearing in the image 50.

As an example, an operation in which the server 10 detects external-scratch 60 on the outer surface of a side portion 2A of the tire 2, as illustrated in FIG. 4, is described in this operation example. In such a case, the imaging device 20 may be installed at a position where the side of the vehicle 3 can be imaged.

Referring to FIG. 3, in step S101, the imaging device 20 transmits an image 50 of the tire 2, captured by the camera, to the server 10.

Specifically, in step S101, the imaging device 20 uses the camera to image the tire 2 and generates the image 50 of the tire 2. The image 50 is preferably a plurality of still or moving images captured continuously. The image 50 may, however, be a single still image. At least a part of the vehicle 3 on which the tire 2 is mounted may also appear in the captured image 50 of the tire 2 in addition to at least a part of the tire 2. As an example, the image 50 illustrated in FIG. 4 is assumed to be transmitted from the imaging device 20 to the server 10 in this operation example. The entire tire 2 and a portion of the vehicle 3 on which the tire 2 is mounted appear in the image 50.

In a case in which the imaging device 20 includes a thermographic camera, the image 50 of the tire 2 may be a thermographic image captured by the thermographic camera. Generally, as the vehicle 3 is driven, the temperature of the inner cavity of the tire 2 increases. The external-scratch 60 on the outer surface of the tire 2 also has a higher surface temperature due to being closer to the inner cavity of the tire 2 than other parts of the tire 2. Therefore, in the process described below, the thermographic image can be used to detect the position, depth, and the like of the external-scratch 60 on the outer surface of the tire 2. By use of the thermographic image, the accuracy of detecting external-scratch to the tire 2 is less likely to deteriorate even when the outer surface of the tire 2 being imaged is soiled by mud or the like, or when the tire 2 is imaged at night. However, the image 50 may be an image captured by any camera, such as a visible light camera.

Referring again to FIG. 3, in step S102, the controller 15 of the server 10 acquires an image of the tire 2.

Specifically, the controller 15 of the server 10 receives the image 50 of the tire 2 from the imaging device 20 via the communication interface 11. However, the controller 15 may also receive the image 50 captured by the imaging device 20 via a computer other than the imaging device 20. The controller 15 may store the received image 50 in the memory 14 in association with the identification information for the tire 2.

In step S102, the controller 15 of the server 10 may furthermore identify the identification information for the tire displayed on the tire 2 or on the vehicle 3 on which the tire 2 is mounted as appearing in the image 50. This enables the controller 15 to identify the tire 2 from the image 50 even if the tire 2 appearing in the image 50 has not been identified in advance. Specifically, by image processing, the controller 15 identifies a display portion 51 indicating the identification information for the tire 2 in the image 50. As illustrated in FIG. 4, the display portion 51 may, for example, be a two-dimensional code such as a Quick Response (QR) code® (QR code is a registered trademark in Japan, other countries, or both) or an Augmented Reality (AR) marker. In such a case, the controller 15 can read the identification information for the tire 2 from the display portion 51, which is a two-dimensional code. The display portion 51 is not, however, limited to a two-dimensional code and may be any display, such as a character string, symbol, graphic, pattern, or one-dimensional code.

The display portion 51, which indicates the identification information of the tire 2, may be displayed at any position. For example, in FIG. 4, display portions 51A and 51B are illustrated. The display portion 51A is provided on the side portion 2A of the tire 2. In such a case, even if the tire 2 is mounted on another vehicle 3 as a result of tire rotation or the like, the identification information for the tire 2 can be identified based on the same display portion 51. The display portion 51B is provided on the vehicle body of the vehicle 3 on which the tire 2 is mounted. In such a case, since the display portion 51 is provided on the vehicle body of the vehicle 3, the visibility of the display portion 51 is less likely to deteriorate even if the outer surface of the tire 2 is soiled by mud or is scratched.

Referring again to FIG. 3, in step S103, the controller 15 of the server 10 identifies one or more reference positions 52 on the outer surface of the tire 2 as appearing in the image 50.

As described above, the reference position 52 is used to identify the position of the external-scratch 60 on the outer surface of the tire 2. For example, the reference position 52 may be a letter, symbol, graphic, or pattern on the outer surface of the tire 2. The information on the reference position 52 of the tire 2 is, for example, associated with a position on the outer surface of the tire 2 via coordinates or other positional information. Since the reference position 52 is on the outer surface of the tire 2, the position of the external-scratch 60 to the tire 2 can be continuously identified based on the same reference position 52 even if the tire 2 is mounted on another vehicle 3 or wheel as a result of tire rotation or the like. Therefore, the accuracy of identifying the position of the external-scratch 60 to the tire 2 is less likely to deteriorate.

Any method can be employed to identify the reference position 52. For example, the controller 15 of the server 10 performs image analysis on the image 50 based on information on the reference position 52 of the tire 2 as stored in the memory 14 in advance. For example, the information on a reference position 52 includes features such as the shape, color, or pattern of the reference position 52. This enables the controller 15 to identify one or more reference positions 52 on the outer surface of the tire 2 as appearing in the image 50. In FIG. 4, three reference positions 52A, 52B, 52C are provided on the outer surface of the side 2A of the tire 2. The three reference positions 52A, 52B, 52C have different features and are distinguishable. The controller 15 may identify at least one of the plurality of reference positions 52A, 52B, 52C on the outer surface of the tire 2 and use the position (or positions) as the reference position 52 of the tire 2. In this way, provision of the plurality of reference positions 52 on the outer surface of the tire 2 makes it easier to identify the reference position 52 even if a portion of the tire 2 is soiled by mud or is damaged. For example, in the example in FIG. 4, in a case which the reference position 52A is soiled by mud and cannot be extracted by image analysis, the controller 15 can use reference position 52B or 52C as a reference to identify the position of the external-scratch 60 by subsequent processing. However, the number of reference positions 52 provided on the outer surface of the tire 2 may be only one.

Referring again to FIG. 3, in step S104, the controller 15 of the server 10 determines the actual length per unit pixel in the image 50 based on the actual length of the reference member associated with the tire 2 and the length of the reference member as appearing in the image 50.

The reference member associated with the tire 2 may, for example, be the rim diameter of the tire 2. Alternatively, the reference member may be a letter, symbol, graphic, or pattern on the outer surface of the tire 2. For example, the above-described reference position 52 may be used as the reference member.

Any method can be employed to determine the actual length per unit pixel. For example, the controller 15 of the server 10 identifies the outline of the reference member appearing in the image 50. The controller 15 identifies the distance between the two most distant points of the identified outline of the reference member as the length of the reference member as appearing in the image 50. The length of the reference member as appearing in the image 50 may be expressed as a number of pixels. The controller 15 can determine the actual length per unit pixel in the image 50 from the number of pixels corresponding to the length of the reference member as appearing in the image 50 and the actual length of the reference member associated with the tire 2. This can improve the accuracy of estimating the depth of the external-scratch 60 to the tire 2 in subsequent processing. However, the actual length per unit pixel in the image 50 may be predetermined.

In step S105, the controller 15 of the server 10 detects the external-scratch 60 on the outer surface of the tire 2 as appearing in the image 50.

Any method can be employed to detect the external-scratch 60. For example, the controller 15 of the server 10 may store, in the memory 14 in advance, an image analysis algorithm for identifying the external-scratch 60 to the tire 2 as appearing in the image 50. The controller 15 uses the image analysis algorithm to detect the outline of the external-scratch 60, such as a cut or crack on the outer surface of the tire 2 as appearing in the image 50, as the external-scratch 60.

In the present embodiment, the image analysis algorithm may be constructed by statistical methods such as machine learning or deep learning. For example, the image analysis algorithm may be constructed by a statistical method using the image 50 of the tire 2 and the outline of the external-scratch 60 in the tire 2 as identified by a human or the like as teacher data. As a result, the detection accuracy of the external-scratch 60 on the outer surface of the tire 2 can be improved by accumulation of teacher data. The image analysis algorithm may, however, include a predetermined arithmetic process not based on a statistical method.

In step S105, the controller 15 then generates positional information for the detected external-scratch 60 relative to the one or more reference positions on the outer surface of the tire 2. The positional information for the external-scratch 60 is, for example, coordinate information with respect to the reference position 52 on the outer surface of the tire 2. In FIG. 4, different coordinates are set for each of the three reference positions 52A, 52B, 52C. The controller 15 can identify the coordinates of the external-scratch 60 based on the positional relationship between the external-scratch 60 and one of the three reference positions 52A, 52B, 52C.

Referring again to FIG. 3, in step S106, the controller 15 of the server 10 estimates the depth of the external-scratch 60 from at least one of the length and the width of the external-scratch 60 on the outer surface of the tire 2 as appearing in the image 50.

Any method can be employed to estimate the depth of the external-scratch 60. For example, the controller 15 of the server 10 may store, in the memory 14 in advance, a correspondence algorithm for estimating the depth of the external-scratch 60 from at least one of the length and width of the external-scratch 60 to the tire 2 as appearing in the image 50. The controller 15 may take the distance between the two most distant points of the outline of the external-scratch 60 as identified in step S105 as the length and the distance between the two most distant points in a direction orthogonal to the direction of the length as the width. The controller 15 may use the actual length per unit pixel in the image 50 as calculated in step S104 when calculating the length and width of the external-scratch 60. The controller 15 then estimates the depth of the external-scratch 60 from at least one of the length and width of the external-scratch 60 using a mapping algorithm. The depth of the external-scratch 60 may be the distance from the outer surface of the tire 2 to the deepest portion of the external-scratch 60, but this example is not limiting.

In the present embodiment, the correspondence algorithm may be constructed by statistical methods such as machine learning or deep learning. For example, the correspondence algorithm may be constructed by a statistical method using at least one of the length and width of the external-scratch 60 to the tire 2 and the depth of the external-scratch 60 as measured by a human or the like as teacher data. As a result, the accuracy of estimating the depth of the external-scratch 60 to the tire 2 can be improved by accumulation of teacher data. The correspondence algorithm may, however, include a predetermined arithmetic process not based on a statistical method.

When the depth of the external-scratch 60 is estimated in step S106, the external-scratch 60 is preferably located within a predetermined range from the ground contact position of the tire 2 in the image 50. The predetermined range from the ground contact position of the tire 2 is preferably the range H from the ground contact position of the tire 2 to the lower edge of the rim of the tire 2 in the height direction in the image 50, as illustrated in FIG. 4. The predetermined range from the ground contact position of the tire 2 is more preferably the range H from the ground contact position of the tire 2 to the lower edge of the rim of the tire 2 in the height direction in the image 50, and the range W between the ends of the rim in the width direction in the image 50. The predetermined range from the ground contact position of the tire 2 is even more preferably the range, in the image 50, between straight lines connecting the center C of the tire 2 and each of the two ends E1 and E2 of the ground contact position of the tire 2 in the width direction in the image 50. The controller 15 may estimate the depth of the external-scratch 60 based on the image 50 in a case in which the external-scratch 60 is located within the predetermined range. In a case in which the external-scratch 60 is thus located near the ground contact position, the load applied to the tire 2 causes the external-scratch 60 to open, making it easier to measure the length or width of the external-scratch 60, which in turn can improve the estimation accuracy of the depth of the external-scratch 60. For this reason, when the image 50 is a plurality of still images or a moving image captured continuously, the controller 15 of the server 10 may determine in step S106 whether the external-scratch 60 is located within a predetermined range from the ground contact position of the tire 2 in the image 50. The controller 15 may select the image (frame) in which the external-scratch 60 is located within the predetermined range for use in estimating the depth of the external-scratch 60 in step S106.

Referring again to FIG. 3, in step S107, the controller 15 of the server 10 outputs the external-scratch information for the tire 2.

In outputting the external-scratch information for the tire 2 in step S107, the controller 15 of the server 10 may associate the positional information and outline of the external-scratch 60 as identified in step S105 and information such as the length, width, and depth of the external-scratch 60 as identified in S106 with the tire identification information for the tire 2 and store the associated information in the memory 14 as the external-scratch information for the tire 2. The external-scratch information for the tire 2 may include information on a plurality of instances of external-scratch 60. In a case in which the external-scratch information for the tire 2 already contains information for external-scratch 60 with the same positional information as was detected in the past, the controller 15 may update the information with the new information on the outline, depth, and the like, or may add the new information to the information as time-series data.

Any method can be employed to output the external-scratch information for the tire 2. For example, the controller 15 of the server 10 may visualize and display the external-scratch information for the tire 2, via the output interface 12 such as a display, with respect to the one or more reference positions 52. Alternatively, the controller 15 may transmit to the terminal device 30, via the communication interface 11, a request to visualize and display the external-scratch information for the tire 2 with respect to the one or more reference positions 52. In such a case, the terminal device 30 can visualize and display the external-scratch information for the tire 2 via a display or the like based on the request received from the server 10. For example, as illustrated in FIG. 5, a screen may be displayed depicting a photograph or illustration of the tire 2 with the position of the external-scratch 60 mapped and highlighted (displayed by shading in the illustrated example) with respect to the reference position 52.

The user of the tire external-scratch monitoring system 1 can thereby easily identify the position of the external-scratch 60 on the outer surface of the tire 2. Since the reference position 52 is identified on the outer surface of the tire 2, the position of the external-scratch 60 to the tire 2 can be continuously identified even if the tire 2 is mounted on another vehicle 3 or wheel. This enables monitoring of the external-scratch 60 over time, such as monitoring of the occurrence of new external-scratch 60 or changes in the depth or the like of the external-scratch 60, in comparison with past external-scratch information for the tire 2. The tire external-scratch monitoring system 1 can thus improve the usefulness of technology for monitoring the external-scratch to the tire 2. Furthermore, in a case in which the external-scratch information for the tire 2 includes information such as the length, width, or depth of the external-scratch 60, the length, width, or depth of the external-scratch 60 can be displayed in addition to the position of the external-scratch 60 on the tire 2, as illustrated in FIG. 5. This can further improve the usefulness of technology for monitoring external-scratch to the tire 2.

Referring again to FIG. 3, in step S108, the controller 15 of the server 10 may cause an alert to be outputted in a case in which the depth of the external-scratch 60 to the tire 2 is outside the predetermined threshold range. The predetermined threshold range may, for example, be threshold values indicating an allowable range of durability of the tire 2. Alternatively, the predetermined threshold range may be associated with at least one of replacement, retreading, or rotation of the tire 2. For example, if the predetermined threshold range is associated with replacement of the tire 2, the controller 15 can cause an alert encouraging replacement of the tire 2 to be outputted in a case in which the external-scratch information for the tire 2 falls outside the predetermined threshold range.

Any method may be employed to output the alert. The controller 15 of the server 10 may display information or output sound or light via the output interface 12. Alternatively, the controller 15 may transmit to the terminal device 30, via the communication interface 11, a request to output the alert. In such a case, the terminal device 30 can output the alert via a display or the like based on the request received from the server 10. The user of the tire external-scratch monitoring system 1 can thereby be encouraged to take action such as replacing, retreading, or rotating the tire 2.

The predetermined threshold range used for outputting the above-described alert may vary depending on the position of the external-scratch 60 on the outer surface of the tire 2, i.e., the positional information for the external-scratch 60 relative to the one or more reference positions 52. For example, as the predetermined threshold range, the controller 15 of the server 10 may store in the memory 14 a plurality of threshold ranges that vary depending on the position relative to the one or more reference positions 52 on the outer surface of the tire 2. Specifically, at positions where the risk of failure is high due to the structure of the tire 2, such as near the edge of the belt or carcass ply, the depth of the external-scratch at which an alert is to be outputted may be set shallower than at other positions. This enables outputting of the alert according to the failure risk at the position of the external-scratch 60 in the tire 2, thereby improving the accuracy with which the alert is outputted.

As described above, in the present embodiment, the server 10, i.e., the tire external-scratch monitoring device, acquires an image 50 of the tire 2. The server 10 then identifies one or more reference positions 52 on the outer surface of the tire 2 as appearing in the image 50 and detects external-scratch 60 on the outer surface of the tire 2 as appearing in the image 50. The server 10 outputs external-scratch information including positional information for the detected external-scratch 60 relative to the one or more reference positions 52 on the outer surface of the tire 2.

According to this configuration, the server 10 can accurately identify the position of the external-scratch 60 on the outer surface of the tire 2 based on the acquired image 50. In particular, since one or more reference positions 52 are identified on the outer surface of the tire 2, the position of the external-scratch 60 to the tire 2 can be continuously identified even if the tire 2 is mounted on another vehicle 3 or wheel. Therefore, according to the present embodiment, the usefulness of technology for monitoring external-scratch to the tire 2 can be improved.

In the above operation example, operations by the tire external-scratch monitoring system 1 to detect the external-scratch 60 on the outer surface of the side portion 2A of the tire 2 have been described, but this example is not limiting. The outer surface of the tire 2 to be processed by the tire external-scratch monitoring system 1 may include at least one of the outer surface of the side portion 2A and the outer surface of a tread portion 2B of the tire 2. In other words, the tire external-scratch monitoring system 1 may be used to detect external-scratch 60 on the outer surface of the tread portion 2B of the tire 2 in addition to or instead of on the side portion 2A of the tire 2. In such a case, the imaging device 20 may be installed at a position where the front or rear of the vehicle 3 can be imaged in order to image the tread portion 2B of the tire 2. As in the above operation example, the server 10 acquires the image 50 of the tread portion 2B of the tire 2 from the imaging device 20. The server 10 then identifies one or more reference positions 52 on the outer surface of the tread portion 2B of the tire 2 as appearing in the image 50 and detects external-scratch 60 on the outer surface of the tread portion 2B of the tire 2 as appearing in the image 50. For example, the reference position 52 may be a letter, symbol, graphic, or pattern on the outer surface of the tread portion 2B of the tire 2. The server 10 outputs external-scratch information including positional information for the detected external-scratch 60 relative to the one or more reference positions 52 on the outer surface of the tread portion 2B of the tire 2. This enables the server 10 to detect and identify the position of external-scratch 60 on the outer surface of the tread portion 2B of the tire 2 in addition to or instead of on the side portion 2A of the tire 2.

Although the present disclosure is based on drawings and embodiments, it is to be noted that various changes and modifications could be made by those skilled in the art based on the present disclosure. Therefore, such changes and modifications are to be understood as included within the scope of the present disclosure. For example, the configurations, functions, and the like included in each embodiment may be reordered in any logically consistent way. Furthermore, the configurations, functions, and the like included in each embodiment can be used in combination with other embodiments. A plurality of configurations, functions, or the like can also be combined into one or divided, or a portion thereof can be omitted.

For example, an embodiment in which a general-purpose computer functions as the server 10 according to the above embodiment is also possible. Specifically, a program describing the processing content for realizing each function of the server 10 according to the above embodiment is stored in the memory of the general-purpose computer, and the program is read and executed by the processor. Accordingly, the present disclosure can also be realized as a program executable by a processor or as a non-transitory computer readable medium storing the program. Examples of non-transitory computer readable media include a magnetic recording device, an optical disc, a magneto-optical recording medium, and a semiconductor memory.

### INDUSTRIAL APPLICABILITY

According to the present disclosure, a tire external-scratch monitoring device, a tire external-scratch monitoring method, and a program that can improve the usefulness of technology for monitoring external-scratch to a tire can be provided.

### Contribution to the Sustainable Development Goals (SDGs) Initiated by the United Nations

SDGs have been proposed to realize a sustainable society. An embodiment of the present disclosure could be technology that contributes to goals such as “No. 9: Build infrastructure for industry and innovation”.

### REFERENCE SIGNS LIST

1 Tire external-scratch monitoring system
2 Tire
2A Side portion
2B Tread portion
3 Vehicle
10 Server (tire external-scratch monitoring device)
11 Communication interface
12 Output interface
13 Input interface
14 Memory
15 Controller
20 Imaging device
30 Terminal device
40 Network
50 Image
51 (51A, 51B) Display portion
52 (52A, 52B, 52C) Reference position
60 External-scratch
H Range in height direction
W Range in width direction
C Center
E1, E2 Ends of ground contact position

1. A tire external-scratch monitoring device comprising a controller configured to:
acquire an image of a tire;
identify one or more reference positions on an outer surface of the tire as appearing in the image;
detect external-scratch on the outer surface of the tire as appearing in the image; and
output external-scratch information including positional information for the detected external-scratch relative to the one or more reference positions on the outer surface of the tire.

2. The tire external-scratch monitoring device according to claim 1, wherein the outer surface includes at least one of an outer surface of a side portion or an outer surface of a tread portion of the tire.

3. The tire external-scratch monitoring device according to claim 1, wherein
the controller is further configured to estimate a depth of the external-scratch from at least one of a length or a width of the external-scratch on the outer surface of the tire as appearing in the image, and
the external-scratch information includes the depth of the external-scratch.

4. The tire external-scratch monitoring device according to claim 3, wherein the controller is configured to determine an actual length per unit pixel in the image based on an actual length of a reference member associated with the tire and a length of the reference member as appearing in the image.

5. The tire external-scratch monitoring device according to claim 3, wherein
the controller is further configured to
determine whether the external-scratch is located within a predetermined range from a ground contact position of the tire in the image, and
output the external-scratch information including the positional information relative to the one or more reference positions based on the image in a case in which the external-scratch is located within the predetermined range.

6. The tire external-scratch monitoring device according to claim 3, wherein
the controller is further configured to
determine whether the external-scratch is located within a predetermined range from a ground contact position of the tire in the image, and
estimate the depth of the external-scratch based on the image in a case in which the external-scratch is located within the predetermined range.

7. The tire external-scratch monitoring device according to claim 5, wherein the predetermined range from the ground contact position of the tire is a range from the ground contact position of the tire to a lower edge of a rim of the tire in a height direction in the image.

8. The tire external-scratch monitoring device according to claim 3, wherein the controller is configured to output an alert in a case in which the depth of the external-scratch is outside a predetermined threshold range.

9. The tire external-scratch monitoring device according to claim 8, wherein the predetermined threshold range varies depending on the positional information for the external-scratch relative to the one or more reference positions.

10. The tire external-scratch monitoring device according to claim 1, wherein the image of the tire is a thermographic image captured by a thermographic camera.

11. The tire external-scratch monitoring device according to claim 1, wherein identifying the one or more reference positions includes identifying at least one reference position among a plurality of reference positions on the outer surface of the tire.

12. The tire external-scratch monitoring device according to claim 1, wherein outputting the external-scratch information includes outputting a request to visualize and display the external-scratch information for the tire with respect to the one or more reference positions.

13. A tire external-scratch monitoring method to be executed by one or more computers, the method comprising:
acquiring an image of a tire;
identifying one or more reference positions on an outer surface of the tire as appearing in the image;
detecting external-scratch on the outer surface of the tire as appearing in the image; and
outputting external-scratch information including positional information for the detected external-scratch relative to the one or more reference positions on the outer surface of the tire.

14. A program configured to cause one or more computers to execute operations, the operations comprising:
acquiring an image of a tire;
identifying one or more reference positions on an outer surface of the tire as appearing in the image;
detecting external-scratch on the outer surface of the tire as appearing in the image; and
outputting external-scratch information including positional information for the detected external-scratch relative to the one or more reference positions on the outer surface of the tire.

15. The tire external-scratch monitoring device according to claim 6, wherein the predetermined range from the ground contact position of the tire is a range from the ground contact position of the tire to a lower edge of a rim of the tire in a height direction in the image.
